(19) United States
(12) Patent Application Publication
(10) Pub. No.: US 2025/0200488 A1
(43) Pub. Date: Jun. 19, 2025

(54) AUTOMATED HUMAN MOTION RECOGNITION WORKSITE AUDITING

(71) Applicant: Craig Douglas Smith, Barragup (AU)

(72) Inventors: Craig Douglas Smith, Barragup (AU); Leigh Jonathan Douglas Drysdale, Mandurah (AU)

(73) Assignee: Craig Douglas Smith, Barragup, WA (AU)

(21) Appl. No.: 18/847,234

(22) PCT Filed: Mar. 14, 2023
(86) PCT No.: PCT/AU2023/050176

§ 371 Date: Sep. 14, 2024

(30) Foreign Application Priority Data
Mar. 14, 2022 (AU) 2022900621

(51) Int. Cl. G06Q 10/0639; G06Q 10/1091; G06V 10/74; G06V 10/764; G06V 20/52; G06V 40/16; G06V 40/20

(52) U.S. Cl. CPC G06Q 10/06395; G06Q 10/06398; G06Q 10/1091; G06V 10/761; G06V 10/764; G06V 20/52; G06V 40/172; G06V 40/23

(57) ABSTRACT

Provided is a system (10) for automated human motion recognition worksite auditing, said system (10) comprising a computer vision sensor (12) arrangeable at a worksite (8) and configured to sense, in real-time, a human body gesture (14) of at least one person active on the worksite (8). The system 10 also includes a processing system (20) arranged in signal communication with the computer vision sensor (12) and including a database (22) of predetermined human body gesture models. The processing system (20) is configured to i) receive said sensed human body gesture; ii) perform human body gesture recognition by comparing said sensed human body gesture to the database (22) of pre-determined human body gesture models; iii) if the human body gesture recognition falls within predetermined statistical ranges, classify such sensed human body gesture as approved or unapproved as occurring; and when approved human body gesture recognition occurs, perform automatic timekeeping during such occurrence for auditing purposes.

### TECHNICAL FIELD

This invention relates broadly to the field of human motion recognition for automated auditing purposes, and specifically to a method and associated system for automated human motion recognition auditing for a worksite.

### BACKGROUND ART

The following discussion of the background art is intended to facilitate an understanding of the present invention only. The discussion is not an acknowledgement or admission that any of the material referred to is or was part of the common general knowledge as at the priority date of the application.

Applicant has identified a need in the art of worksite management, specifically for geographically remote worksites, in maintaining operating and safety standards for personnel. For example, in the resources industry, geographical exploration, such as mineral exploration drilling, is a vital process for discovery of new mineral prospects. However, such exploration often takes places in remote locations, where it is difficult to ensure exploration personnel adhere to safety and operational practices.

Similarly, such remote exploration tasks are typically performed on a ‘cost-to-client’ basis, where time spent and operations performed are billed to client. This presents further challenges in ensuring that personnel time and operational practices are properly adhered to. For example, in exploration drilling, drill bits are a consumable with improper use or replacement of a drill bit typically costing client several thousand dollars.

One solution for such adherence to practices, specific on-site regulatory requirements and monitoring of consumable usage is to provide a dedicated on-site personnel inspector or manager, but this adds further costs and introduces a human element, which is fallible and subject to influence by other team members on a worksite.

Prior art monitoring systems exist, such as U.S. Pat. No. 7,200,266 to Ozer et al., which describes a system that can be used to detect, recognise, and analyse people or other objects in security checkpoints, public-places, parking lots, or in similar environments under surveillance to detect the presence of certain objects of interests (e.g. human, bag, dog, etc.), and to identify their activities for security and other purposes in real-time. The system can detect a range of activities for different applications. The method detects any new object introduced into a known environment and then classifies the object regions to human body parts or to other non-rigid and rigid objects. By comparing the detected objects with the graphs from a database in the system, the methodology is able to identify object parts and to decide on the presence of the object of interest in video sequences.

Similarly, US 2016/0328604 to Bulzacki teaches a system for monitoring gesture data points identifying a location of a body part of one or more monitored individuals with respect to a reference point on the body in a gaming environment, such as a casino, with a rules enforcement component configured to determine when one or more identified gestures of interest correspond to activity that contravenes one or more of rules stored in an electronic database.

While these prior art systems are in a similar field to the present invention, none of them are fit-for-purpose in monitoring and enforcing adherence to specific on-site regulatory requirements, particularly at remote exploration and mining sites. In particular, required on-site actions are not always in compliance with requirements, which is allowable under certain circumstances, but conventional approaches do not cater for various grades of allowable actions, amongst other shortcomings. For example, training of personnel on a worksite requires learning how to comply with, e.g. legislative training requirements, which takes time and non-compliant behaviour is not a necessarily a contravention of requirements.

The current invention was conceived with the goal in mind of maintaining operating, training and safety standards for personnel on remote worksites, where actions are not easily classifiable as allowed or not allowed.

### SUMMARY OF THE INVENTION

The skilled addressee is to appreciate that reference herein to ‘computer vision’ generally refers to technology for building artificial systems that obtain information from images or multi-dimensional data, and any suitable configuration that deals with how computers or similar processing systems are able to gain a high-level and/or detailed understanding from digital images or videos, i.e. automating tasks that the human visual system is able to perform, as is known in the art of computer and visual engineering.

Similarly, reference herein to ‘machine learning’ generally refers to the application and/or use of algorithms and statistical models by a processor or processing system to effectively perform a specific task without using explicit instructions, but rather via reliance on patterns and inference.

It is yet further to be appreciated that reference herein to ‘real-time’ is to be understood as meaning an instance of time that may include a delay typically resulting from processing, calculation and/or transmission times inherent in computer processing systems. These transmission and calculations times, albeit of generally small duration, do introduce some measurable delay, i.e. typically less than a second or within milliseconds, but an output is provided relatively quickly or within substantial ‘real-time’.

Additionally, reference herein to ‘worksite’ is used in a broad sense and typically refers to any location or site where manual labour or work is performed, such as a mine site, exploration drill site, labour site, construction site, or the like. Similarly, auditing is defined as a verification activity, such as inspection or examination, of a process or quality system, to ensure compliance to requirements, for example, regulated steps required when performing a specific task, steps undertaken during training to perform a task, compliance with legislative requirements, and/or the like. Accordingly, the skilled addressee is to appreciate that such auditing comprises a range of activities that are not necessarily classifiable using a binary approach of ‘compliant’ or ‘non-compliant’ only.

According to a first aspect of the invention there is provided a system for automated human motion recognition worksite auditing, said system comprising:
a computer vision sensor arrangeable at a worksite and configured to sense, in real-time, a human body gesture of at least one person active on said worksite; and
a processing system arranged in signal communication with the computer vision sensor and including a database of predetermined human body gesture models, said processing system configured to:
   i) receive said sensed human body gesture;
   ii) perform human body gesture recognition by comparing said sensed human body gesture to the database of pre-determined human body gesture models;
   iii) if the human body gesture recognition falls within predetermined statistical ranges, classify such sensed human body gesture as approved or unapproved as occurring; and
   iv) when approved human body gesture recognition occurs, perform automatic timekeeping during such occurrence for auditing purposes.

In an embodiment, the sensed human body gesture includes human facial recognition.

In an embodiment, the processing system is configured to perform machine learning on the sensed human body gesture in order to improve a statistical comparability of sensed human body gestures with the database of pre-determined human body gesture models.

Typically, the database of predetermined human body gesture models includes models of approved and unapproved human body gestures for comparison purposes.

In an embodiment, the predetermined statistical ranges denote an overlap of similarity or dissimilarity between the sensed human body gesture and the predetermined human body gesture models.

In an embodiment, the predetermined statistical ranges comprise 0%-50% for non-recognition of human body gesture and <50%-100% for recognised human body gesture.

In an embodiment, the processing system is configured to classify non-recognised human body gesture as unapproved.

In an embodiment, the processing system is configured to classify recognised human body gesture as approved.

Typically, the pre-determined human body gesture models on the database are user-selectable and/or user-definable.

In an embodiment, the processing system is configured to pause or suspend automatic timekeeping when unapproved human body gesture recognition occurs.

In an embodiment, the processing system is configured to raise an alarm when unapproved human body gesture recognition occurs for more than a predetermined period of time.

In an embodiment, the computer vision sensor comprises a sensor selected from a non-exhaustive group consisting of a camera (still and/or video), a lidar sensor (light imaging detection and ranging), a radar sensor (radio detection and ranging), an ultrasonic sensor, a sonar sensor, a proximity sensor, and a laser sensor.

Typically, the computer vision sensor comprises a plurality of sensors arrangeable to sense human body gesture at the worksite.

Typically, the computer vision sensor is configured to sense human body gesture of a plurality of personnel active on the worksite simultaneously.

Typically, the processing system is arranged in wired and/or wireless signal communication with the computer vision sensor.

Typically, approved human body gestures are defined as human body gesture models on the database suitable for the worksite.

Typically, unapproved human body gestures are defined as human body gesture models on the database unsuitable for the worksite.

In an embodiment, unapproved human body gesture comprises the presence of a person at an unauthorised area of the worksite.

In an embodiment, the computer vision sensor is arranged on a drill rig, a vehicle or similar piece of worksite equipment or machinery.

According to a second aspect of the invention there is provided a worksite comprising a system for automated human motion recognition worksite auditing, in accordance with the first aspect of the invention above.

According to a third aspect of the invention there is provided a method for automated human motion recognition worksite auditing, said method comprising the steps of:
sensing, in real-time, a human body gesture of at least one person active on said worksite by means of a computer vision sensor;
performing human body gesture recognition, via a processing system, by comparing said sensed human body gesture to a database of pre-determined human body gesture models;
if the human body gesture recognition falls within predetermined statistical ranges, classifying such sensed human body gesture as approved or unapproved as occurring by means of the processing system; and
when approved human body gesture recognition occurs, via the processing system, performing automatic timekeeping during such occurrence for auditing purposes.

In an embodiment, the step of sensing a human body gesture includes human facial recognition.

In an embodiment, the method includes the step of performing machine learning on the sensed human body gesture, via the processing system, in order to improve a statistical comparability of sensed human body gestures with the database of pre-determined human body gesture models.

Typically, the database of predetermined human body gesture models includes models of approved and unapproved human body gestures for comparison purposes.

In an embodiment, the predetermined statistical ranges denote an overlap of similarity or dissimilarity between the sensed human body gesture and the predetermined human body gesture models.

In an embodiment, the predetermined statistical ranges comprise 0%-50% for non-recognition of human body gesture and <50%-100% for recognised human body gesture.

In an embodiment, the method comprises classifying non-recognised human body gesture as unapproved.

In an embodiment, the method comprises classifying recognised human body gesture as approved.

Typically, the method comprises a step of pre-selecting or pre-defining the human body gesture models on the database.

Typically, the method comprises a step of pausing or suspending automatic timekeeping when unapproved human body gesture recognition occurs

In an embodiment, the method includes a step of raising an alarm when unapproved human body gesture recognition occurs for more than a predetermined period of time.

Typically, approved human body gestures are defined as human body gesture models on the database suitable for the worksite.

Typically, unapproved human body gestures are defined as human body gesture models on the database unsuitable for the worksite.

In an embodiment, unapproved human body gesture comprises the presence of a person at an unauthorised area of the worksite.

According to a further aspect of the invention there is provided a system and associated method for automated human recognition worksite auditing, substantially as herein described and/or illustrated.

### BRIEF DESCRIPTION OF THE DRAWINGS

The description will be made with reference to the accompanying drawings in which:

FIG. 1 is a diagrammatic overview representation of one embodiment of a system for automated human motion recognition worksite auditing, in accordance with an aspect of the invention; and

FIG. 2 is a diagrammatic representation of steps, represented by blocks, for a method for automated human motion recognition worksite auditing, in accordance with an aspect of the present invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

Broadly, the present invention provides for a system 10 and associated method 30 for automated human motion recognition worksite auditing, including a worksite 8 having such a system 10. The system 10 facilitates in automatically monitoring, for example, operating and safety standards, training standards and/or legislative standards for personnel on worksites. In particular, worksites may be subject to national laws and regulations around operations, safety and training standards, which the present invention is configured and adapted to monitor automatically. While the present invention finds particular application on remote worksites, the skilled addressee is to appreciate that such monitoring as described herein may be applicable to any suitable worksite.

In particular, the present invention relies on automatic sensing of human body gesture in order to determine whether such sensed human body gesture falls within approved or unapproved human body gesture for a particular worksite, with such sensed human body gesture discernible via comparison to a database 22 of pre-determined human body gesture models relying on predetermined statistical ranges to enable graded discernment of body gestures.

As generally known in the field of human body gesture study, a gesture of the human body is generally a special movement or position of the body and the way a person maintains his/her physical state. Accordingly, human body gesture or motion recognition is the extraction, classification, and identification of human gesture features and natural language description. Human gesture recognition generally refers to the process of processing and analysing human action behaviours using a computer and then performing a process of identifying and classifying on such a basis.

A purpose of such human body gesture recognition is typically to output structural parameters of the person's overall or partial limbs, such as the outline of the human body, the position and orientation of the head, and the position of the human joint points or the category of parts. The skilled addressee is further to appreciate that such sensed human body gesture may also include human facial recognition. For example, such facial recognition may be used for automatic identification of a person for auditing purposes, as described below.

Accordingly, different methods may be utilised by a processing system 20, as described herein, to perform such human body gesture recognition. For example, a human body gesture recognition algorithms may rely on a three-dimensional model reconstruction method, which extracts three-dimensional features from human body gesture samples to construct a three-dimensional model, or a human body appearance model method, which establishes a two-dimensional model by acquiring the shape characteristics of the human body and uses such a model matching method to complete the recognition, and/or 3D tracking of human motion using visual skeletonization according to motion characteristics. Similarly conventional facial recognition techniques may also be used for facial recognition purposes. Of course, variations hereon are possible and within the scope of the present invention.

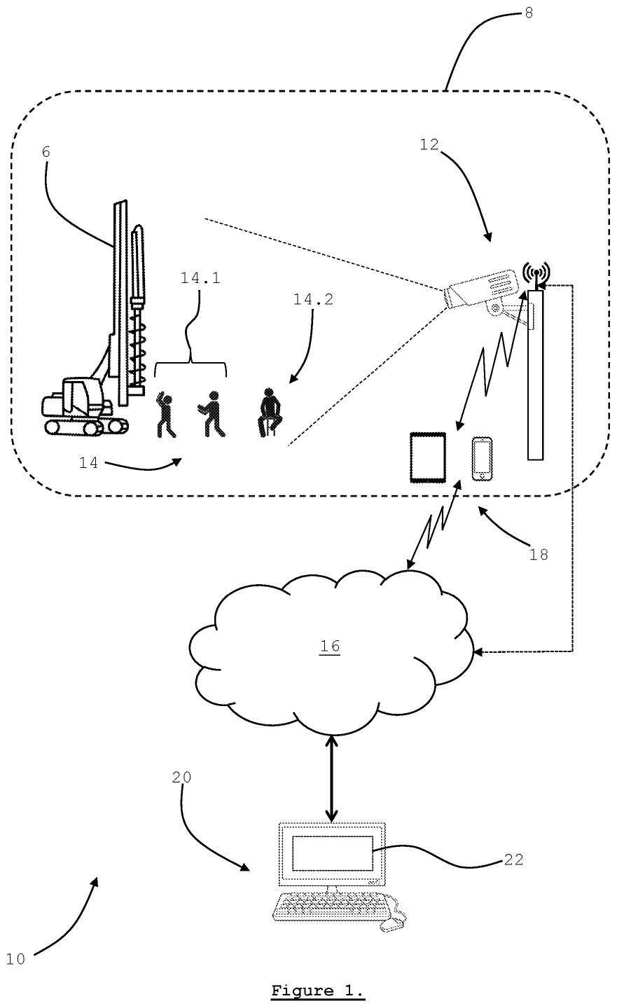

Referring now to FIG. 1 of the accompanying drawings, there is broadly exemplified a system 10 for automated human motion recognition worksite auditing. The system 10 generally comprises a computer vision sensor 12 and a processing system 20.

The computer vision sensor 12 is arrangeable at a worksite 8 and is configured to sense, in real-time, a human body gesture 14 of at least one person active on said worksite 8. In a typical embodiment, the computer vision sensor 12 is configured to sense human body gesture of a plurality of personnel active on the worksite 8 simultaneously.

To this end, the computer vision sensor 12 may be arranged on, for example, a drill rig 6, or a vehicle or similar piece of worksite equipment or machinery. Similarly, the computer vision sensor 12 may form part of a mobile telephone or tablet device 18, which may also serve as output from the processing system 22.

The computer vision sensor 12 may take a variety of forms, requirements depending, and may include any one or more of a camera (still and/or video), a lidar sensor (light imaging detection and ranging), a radar sensor (radio detection and ranging), an ultrasonic sensor, a sonar sensor, a proximity sensor and/or a laser sensor, as generally known in the art of computer vision. Typically, the computer vision sensor 12 comprises a plurality of sensors arrangeable to sense human body gestures, including possible facial recognition, at the worksite 8.

The system 10 also includes processing system 20 which is arranged in signal communication with the computer vision sensor 12. Typically, the processing system is arranged in wired and/or wireless signal communication with the computer vision sensor 12 by means of a suitable communications network, such as a mobile phone network, a satellite network, a radio network, the Internet, and/or the like. Such network 16 facilitates signal communication between the computer vision sensor 12, the processing system 20, as well as remote user devices 18 which can be used to provide feedback on system output, or the like. For example, a remote worksite may only be able to communicate via a satellite network due to lack of other communications infrastructure, etc.

Processing system 20 generally includes a database 22 of predetermined human body gesture models, with the processing system 20 configured to receive the sensed human body gesture 14 from the worksite, often in real-time, and to perform human body gesture recognition by comparing said sensed human body gesture 14 to the database 22 of pre-determined human body gesture models. In general, if the human body gesture recognition falls within predetermined statistical ranges, the processing system 20 classifies such sensed human body gesture as ‘approved’ or ‘unapproved’ as it occurs for auditing purposes.

The skilled addressee is to appreciate that such auditing purposes may be user-configurable depending on worksite requirements. Typically, the database 22 of predetermined human body gesture models includes models of approved and unapproved human body gestures for comparison purposes. Of course, the pre-determined human body gesture models on the database 22 are typically user-selectable and/or user-definable according to requirements for a particular worksite 8.

For example, in the exemplified embodiment where the worksite 8 comprises an exploration drill site, approved human body gestures generally comprises any suitable human body gesture or motion 14.1 related to the proper performance of tasks for performing exploration drilling, such as operating the drill rig, changing a drill bit, or the like. Conversely, unapproved human body gestures 14.2 may include sitting down, looking at a mobile phone, venturing dangerously near operating equipment, such as a drill, and/or the like.

Typically, approved human body gestures are defined as human body gesture models on the database 22 which is suitable for the worksite 8. Similarly, unapproved human body gestures are generally defined as human body gesture models on the database 22 unsuitable for the worksite 8. In one embodiment, unapproved human body gesture may also comprise the presence of a person at an unauthorised area of the worksite, e.g. a person enters a specific area which is dangerous, or the like.

The system 10 may also be configured to identify particular persons on the worksite 8 via facial recognition. For example, certain personnel may have specific roles monitorable via certain approved human body gesture models on the database 22. Specific personnel, as identifiable via facial recognition, may have certain approved human body gestures whilst other personnel do not. For example, some personnel may be certified for working at heights, or in confined spaces, or with specific equipment, and/or a trainer and student, or the like, which the system 10 is able to monitor via facial recognition of personnel as well as specific human body gesture sensing. It is therefore possible to have a person perform an ‘approved’ gesture, but that person is not qualified to do so, which is thus monitorable for auditing purposes, safety, training and/or operational compliance.

The skilled addressee is to appreciate that, as the database 22 may not include all possibilities and/or permutations of human body gesture or motion, the processing system 20 generally classifies sensed human body gesture according to predetermined statistical ranges, i.e. when a sensed human body gesture is not an exact match for a model in the database 22, but corresponds in a statistically significant manner.

Accordingly, the predetermined statistical ranges typically denote an overlap of similarity or dissimilarity between the sensed human body gesture and the predetermined human body gesture models in the database 22. For example, in an embodiment, the predetermined statistical ranges comprise 0%-50% for non-recognition of human body gesture and <50%-100% for recognised human body gesture. Similarly, if there is a 70% similarity between an approved human body gesture model in the database 22 and a sensed human body gesture, the processing system 20 may classify it as approved. For example, during ongoing training of personnel, the predetermined statistical ranges may be varied to ensure stricter compliance with requirements the longer a person performs such training on a worksite. Of course, variations on such statistical ranges are expected and within the scope of the present invention.

In one embodiment, the processing system 20 is configured to perform machine learning on the sensed human body gestures over time in order to improve a statistical comparability of sensed human body gestures with the database 22 of pre-determined human body gesture models. Such machine learning can be used to improve the sensing and classification of the system 10 the more the system is used to sense and classify human body gestures.

In one embodiment, the processing system 20 may be configured to classify non-recognised human body gesture as unapproved and to classify recognised human body gesture as approved, with machine learning applied over time to expand the models on the database 22 in order to improve such statistical comparability of sensed human body gestures. This approach may be particularly useful where a worksite is subject to a large variety of sensed human body gestures, for example.

In a typical embodiment, the processing system 20 is configured to perform automatic timekeeping for auditing or billing purposes when approved human body gesture recognition occurs. For example, if a drill rig operator performs approved gestures, then such time spent may be logged in order to charge a client. However, if unapproved gestures are performed, such as sitting down or looking at a mobile phone, then such time may be logged which is not billable. In one embodiment, the processing system 20 may also be configured to raise an alarm when unapproved human body gesture recognition occurs, for example when a person does something against safety protocol, or the like.

In an embodiment, the processing system 20 is configured to pause or suspend automatic timekeeping when unapproved human body gesture recognition occurs. In one embodiment, the processing system 20 is configured to raise an alarm when unapproved human body gesture recognition occurs for more than a predetermined period of time. For example, worksites do not necessarily place a ban on certain activities, like taking a break, but such actions are monitorable for auditing purposes to facilitate compliance with regulatory compliance, or the like.

For example, during training of personnel on a worksite, a legislative or regulatory framework may require a trainee to perform certain tasks during a work shift on a worksite, and/or to perform certain tasks for a prescribed duration of the shift, or for a certain number of iterations, etc. The system 0 finds particular application in such training monitoring in monitoring such tasks performed in compliance with legislative training requirements and certifications.

In the manner described, the system 10 for automated human motion recognition worksite auditing is able to provide ‘graded’ monitoring and interpretation of approved and unapproved activity due to the use of the predetermined statistical ranges, which may also be improved via machine learning. Additionally, by using automatic timekeeping when approved human body gesture recognition occurs, with the ability to suspend such timekeeping if activity falls outside said predetermined statistical ranges, facilitates higher-quality regulatory compliance allowing various grades of allowable actions, which is more analogous to having a human manager on site.

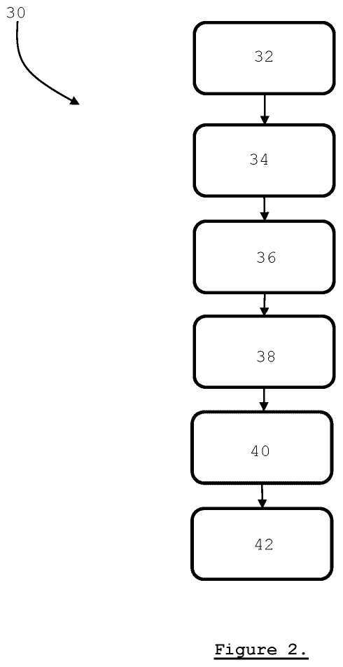

Referring now to FIG. 2 of the accompanying drawings, the skilled addressee is further to appreciate that the present invention includes an associated method 30 for automated human motion recognition worksite auditing. The method 30 typically comprises the steps of sensing 32, in real-time, a human body gesture of at least one person active on a worksite 8 by means of a computer vision sensor 12; 34 performing human body gesture recognition, via a processing system 20, by comparing said sensed human body gesture to a database 22 of pre-determined human body gesture models; and if the human body gesture recognition falls within predetermined statistical ranges, classifying 36 such sensed human body gesture as approved or unapproved as occurring for auditing purposes.

The method also comprises the step of performing machine learning 38 on the sensed human body gesture, via the processing system 20, in order to improve a statistical comparability of sensed human body gestures with the database 22 of pre-determined human body gesture models. Typically, the method 30 also comprises a step of performing automatic timekeeping 40, via the processing system 20, for billing purposes when approved human body gesture recognition occurs. In an embodiment, the method 30 may also include a step of raising an alarm 42 when unapproved human body gesture recognition occurs.

Applicant believes it particularly advantageous that the present invention provides for a system 10 which is able to automatically sense and discern approved and unapproved human body gestures or motions for safety and/or operational auditing purposes on a specific worksite. Additionally, such approved or unapproved human body gesture is configurable according to requirements of the worksite. In the manner described, the present invention is able to provide monitoring which is more analogous to having a human manager on site, with resulting human capital benefits on a work site.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A system for automated human motion recognition worksite auditing, said system comprising:
a computer vision sensor arrangeable at a worksite and configured to sense, in real-time, a human body gesture of at least one person active on said worksite; and
a processing system arranged in signal communication with the computer vision sensor including a database of predetermined human body gesture models, said processing system configured to:
i) receive said sensed human body gesture;
ii) perform human body gesture recognition by comparing said sensed human body gesture to the database of pre-determined human body gesture models;
iii) if the human body gesture recognition falls within predetermined statistical ranges, classify such sensed human body gesture as approved or unapproved as occurring; and
iv) when approved human body gesture recognition occurs, perform automatic timekeeping during such occurrence for auditing purposes.

2. The system of claim 1, wherein the sensed human body gesture includes human facial recognition.

3. The system of either of claim 1 or 2, wherein the processing system is configured to perform machine learning on the sensed human body gesture in order to improve a statistical comparability of sensed human body gestures with the database of pre-determined human body gesture models.

4. The system of any of claims 1 to 3, wherein the database of predetermined human body gesture models includes models of approved and unapproved human body gestures for comparison purposes.

5. The system of any of claims 1 to 4, wherein the predetermined statistical ranges denote an overlap of similarity or dissimilarity between the sensed human body gesture and the predetermined human body gesture models.

6. The system of any of claims 1 to 5, wherein the predetermined statistical ranges comprise 0%-50% for non-recognition of human body gesture and <50%-100% for recognised human body gesture.

7. The system of any of claims 1 to 6, wherein the processing system is configured to classify non-recognised human body gesture as unapproved.

8. The system of any of claims 1 to 7, wherein the processing system is configured to classify recognised human body gesture as approved.

9. The system of any of claims 1 to 8, wherein the pre-determined human body gesture models on the database are user-selectable and/or user-definable.

10. The system of any of claims 1 to 9, wherein the processing system is configured to pause or suspend automatic timekeeping when unapproved human body gesture recognition occurs.

11. The system of any of claims 1 to 10, wherein the processing system is configured to raise an alarm when unapproved human body gesture recognition occurs for more than a predetermined amount of time.

12. The system of any of claims 1 to 11, wherein the computer vision sensor comprises a sensor selected from a non-exhaustive group consisting of a camera (still and/or video), a lidar sensor (light imaging detection and ranging), a radar sensor (radio detection and ranging), an ultrasonic sensor, a sonar sensor, a proximity sensor, and a laser sensor.

13. The system of any of claims 1 to 12, wherein the computer vision sensor comprises a plurality of sensors arrangeable to sense human body gesture at the worksite.

14. The system of any of claims 1 to 13, wherein the computer vision sensor is configured to sense human body gesture of a plurality of personnel active on the worksite simultaneously.

15. The system of any of claims 1 to 14, wherein the processing system is arranged in wired and/or wireless signal communication with the computer vision sensor.

16. The system of any of claims 1 to 15, wherein approved human body gestures are defined as human body gesture models on the database suitable for the worksite.

17. The system of any of claims 1 to 16, wherein unapproved human body gestures are defined as human body gesture models on the database unsuitable for the worksite.

18. The system of any of claims 1 to 17, wherein unapproved human body gesture comprises the presence of a person at an unauthorised area of the worksite.

19. The system of any of claims 1 to 18, wherein the computer vision sensor is arranged on a drill rig, a vehicle or similar piece of worksite equipment or machinery.

20. A worksite comprising a system for automated human motion recognition worksite auditing in accordance with any of claims 1 to 19.

21. A method for automated human motion recognition worksite auditing, said method comprising the steps of:
sensing, in real-time, a human body gesture of at least one person active on said worksite by means of a computer vision sensor;
performing human body gesture recognition, via a processing system, by comparing said sensed human body gesture to a database of pre-determined human body gesture models;
if the human body gesture recognition falls within predetermined statistical ranges, classifying such sensed human body gesture as approved or unapproved as occurring by means of the processing system; and
when approved human body gesture recognition occurs, via the processing system, performing automatic timekeeping during such occurrence for auditing purposes.

22. The method of claim 21, wherein the step of sensing a human body gesture includes human facial recognition.

23. The method of either of claim 21 or 22, which includes the step of performing machine learning on the sensed human body gesture, via the processing system, in order to improve a statistical comparability of sensed human body gestures with the database of pre-determined human body gesture models.

24. The method of any of claims 21 to 23, wherein the database of predetermined human body gesture models includes models of approved and unapproved human body gestures for comparison purposes.

25. The method of any of claims 21 to 24, wherein the predetermined statistical ranges denote an overlap of similarity or dissimilarity between the sensed human body gesture and the predetermined human body gesture models.

26. The method of any of claims 21 to 25, wherein the predetermined statistical ranges comprise 0%-50% for non-recognition of human body gesture and <50%-100% for recognised human body gesture.

27. The method of any of claims 21 to 26, which comprises classifying non-recognised human body gesture as unapproved.

28. The method of any of claims 21 to 27, which comprises classifying recognised human body gesture as approved.

29. The method of any of claims 21 to 28, which comprises a step of pre-selecting or pre-defining the human body gesture models on the database.

30. The method of any of claims 21 to 29, which comprises a step of pausing or suspending, via the processing system, the automatic timekeeping when unapproved human body gesture recognition occurs.

31. The method of any of claims 21 to 30, which includes a step of raising an alarm when unapproved human body gesture recognition occurs for longer than a predetermined period of time.

32. The method of any of claims 21 to 32, wherein approved human body gestures are defined as human body gesture models on the database suitable for the worksite.

33. The method of any of claims 21 to 32, wherein unapproved human body gestures are defined as human body gesture models on the database unsuitable for the worksite.

34. The method of claims 21 to 33, wherein unapproved human body gesture comprises the presence of a person at an unauthorised area of the worksite.
